(19) United States
(12) Patent Application Publication
(10) Pub. No.: US 2024/0045736 A1
(43) Pub. Date: Feb. 8, 2024

(54) REORDERING WORKLOADS TO IMPROVE CONCURRENCY ACROSS THREADS IN PROCESSOR-BASED DEVICES

(71) Applicant: QUALCOMM Incorporated, San Diego, CA (US)

(72) Inventors: Alfredo Olegario Saucedo, San Diego, CA (US); Tate Hornbeck, Cambridge, MA (US); Robert Vanreenen, San Diego, CA (US)

(21) Appl. No.: 17/816,833

(22) Filed: Aug. 2, 2022

(51) Int. Cl. G06F 9/50

(52) U.S. Cl. CPC G06F 9/5083

(57) ABSTRACT

Reordering workloads to improve concurrency across threads in processor-based devices is disclosed herein. In this regard, in some exemplary aspects, a processor-based device receives a plurality of workloads from a requestor, and constructs a weighted dependency graph based on the plurality of workloads. The weighted dependency graph comprises a plurality of vertices that each correspond to a workload of the plurality of workloads, and further comprises one or more directed edges that each connects two vertices of the plurality of vertices and indicates a dependency between a corresponding two workloads of the plurality of workloads. After generating the weighted dependency graph, the processor-based device performs a topological sort of the weighted dependency graph, and generates a workload execution order based on the topological sort. By scheduling workload execution according to the workload execution order, concurrency among threads may be maximized and processor resources may be more efficiently utilized.

### BACKGROUND

### Field of the Disclosure

The technology of the disclosure relates generally to multi-thread processing in processor-based devices.

### II. BACKGROUND

Modern processor-based devices include a dedicated processing unit known as a graphics processing unit (GPU) to accelerate the rendering of graphics and video data for display. A GPU may be implemented as an integrated element of a general-purpose central processing unit (CPU), or as a discrete hardware element that is separate from the CPU. Due to their highly parallel architecture and structure (including, e.g., multiple cores each having its own graphics hardware pipeline), a GPU executes algorithms that process large blocks of data in parallel more efficiently than general-purpose CPUs. For example, GPUs may use a mode known as “tile rendering” or “bin-based rendering” to render a three-dimensional (3D) graphics image. The GPU subdivides an image, which can be decomposed into triangles, into a number of smaller tiles. The GPU then determines which triangles making up the image are visible in each tile and renders each tile in succession, using fast on-chip memory in the GPU to hold the portion of the image inside the tile. Once the tile has been rendered, the on-chip memory is copied out to its proper location in system memory for outputting to a display, and the next tile is rendered.

The process of rendering a tile by the GPU can be further subdivided into multiple operations that may be performed concurrently in separate processor cores or graphics hardware pipelines. For example, tile rendering may involve a tile visibility thread executing on a first processor core, a rendering thread executing on a second processor core, and a resolve thread executing on a third processor core. The purpose of the tile visibility thread is to determine which triangles contribute fragments to each of the tiles, with the result being a visibility stream that contains a bit for each triangle that was checked, and that indicates whether the triangle was visible in a given tile. The visibility stream is compressed and written into the system memory. The GPU also executes a rendering thread to draw the portion of the image located inside each tile, and to perform pixel rasterization and shading. Triangles that are not culled by the visibility stream check are rendered by this thread. Finally, the GPU may also execute a resolve thread to copy the portion of the image contained in each tile out to the system memory. After the rendering of a tile is complete, color content of the rendered tile is resolved into the system memory before proceeding to the next tile.

As noted above, using separate processor cores or graphics hardware pipelines to execute, e.g., the tile visibility thread and the rendering thread in parallel can result in improved GPU performance. However, cross-thread resource dependencies between workloads being executed by the separate cores may limit the ability of the GPU to concurrently execute the workloads. For example, one GPU core may need to stall execution of a workload that is dependent on the results of a workload that is still executing in another GPU core. This may lead to underutilization of the GPU's processing resources and increased execution time. Note that, while the issue of concurrency being affected by cross-thread dependencies is discussed herein in the context of multi-core GPUs, similar issues may arise with multi-core processor-based devices in which cross-thread dependencies may arise.

### SUMMARY OF THE DISCLOSURE

Aspects disclosed in the detailed description include reordering workloads to improve concurrency across threads in processor-based devices. Related apparatus, methods, and computer-readable media are also disclosed. In this regard, in some exemplary aspects disclosed herein, a processor-based device (e.g., using a workload execution reordering circuit of a graphics processing unit (GPU), or by executing a driver or other software comprising a workload execution reordering process) receives a plurality of workloads from a requestor, such as an application or Application Programming Interface (API). The processor-based device constructs a weighted dependency graph based on the plurality of workloads, wherein the weighted dependency graph comprises a plurality of vertices that each correspond to a workload of the plurality of workloads, and further comprises one or more directed edges that each connects two of the vertices and indicates a dependency between a corresponding two workloads. In some aspects, a directed edge that represents a cross-thread dependency may be associated with an edge weight that is derived based on a distance between the two vertices. Some aspects may generate a vertex weight for each vertex corresponding to a workload that is independent of a cross-thread dependency. After generating the weighted dependency graph, the processor-based device performs a topological sort of the weighted dependency graph (e.g., based on the edge weights and/or the vertex weights, if applicable). Some aspects may provide that the processor-based device may assign a vertex priority to each vertex of the plurality of vertices, and process the plurality of vertices in an order indicated by the vertex priority of each vertex. Finally, the processor-based device generates a workload execution order based on the topological sort. According to some aspects, the processor-based device may use the generated workload execution order to schedule an independent workload among the plurality of workloads to execute during idle time (i.e., time during which a processor would otherwise stall due to dependencies between workloads) between two dependent workloads among the plurality of workloads. In this manner, concurrency among threads may be maximized through the more efficient use of processor resources.

In another aspect, a processor-based device is provided. The processor-based device comprises a workload execution reordering circuit that is configured to receive a plurality of workloads from a requestor. The workload execution reordering circuit is further configured to construct a weighted dependency graph based on the plurality of workloads, wherein the weighted dependency graph comprises a plurality of vertices, each corresponding to a workload of the plurality of workloads, and one or more directed edges, each connecting two vertices of the plurality of vertices and indicating a dependency between a corresponding two workloads of the plurality of workloads. The workload execution reordering circuit is also configured to perform a topological sort of the weighted dependency graph. The workload execution reordering circuit is additionally configured to generate a workload execution order based on the topological sort.

In another aspect, a processor-based device is provided. The processor-based device comprises a means for receiving a plurality of workloads from a requestor. The processor-based device further comprises a means for constructing a weighted dependency graph based on the plurality of workloads, wherein the weighted dependency graph comprises a plurality of vertices, each corresponding to a workload of the plurality of workloads, and one or more directed edges, each connecting two vertices of the plurality of vertices and indicating a dependency between a corresponding two workloads of the plurality of workloads. The processor-based device also comprises a means for performing a topological sort of the weighted dependency graph. The processor-based device additionally comprises a means for generating a workload execution order based on the topological sort.

In another aspect, a method for reordering workloads to improve concurrency across threads is provided. The method comprises receiving, by a workload execution reordering process executing on a processor-based device, a plurality of workloads from a requestor. The method further comprises constructing a weighted dependency graph based on the plurality of workloads, wherein the weighted dependency graph comprises a plurality of vertices, each corresponding to a workload of the plurality of workloads, and one or more directed edges, each connecting two vertices of the plurality of vertices and indicating a dependency between a corresponding two workloads of the plurality of workloads. The method also comprises performing a topological sort of the weighted dependency graph. The method additionally comprises generating a workload execution order based on the topological sort.

In another aspect, a non-transitory computer-readable medium is provided. The non-transitory computer-readable medium stores thereon computer-executable instructions that, when executed by a processor of a processor-based device, cause the processor to receive a plurality of workloads from a requestor. The computer-executable instructions further cause the processor to construct a weighted dependency graph based on the plurality of workloads, wherein the weighted dependency graph comprises a plurality of vertices, each corresponding to a workload of the plurality of workloads, and one or more directed edges, each connecting two vertices of the plurality of vertices and indicating a dependency between a corresponding two workloads of the plurality of workloads. The computer-executable instructions also cause the processor to perform a topological sort of the weighted dependency graph. The computer-executable instructions additionally cause the processor to generate a workload execution order based on the topological sort.

### BRIEF DESCRIPTION OF THE FIGURES

FIG. 1 is a block diagram of an exemplary processor-based device configured to reorder workloads to improve concurrency across threads, according to some aspects;

FIGS. 2A and 2B are block diagrams illustrating how reordering workloads according to some aspects disclosed herein may improve concurrency by reducing the occurrence of stalls during execution threads;

FIGS. 3A and 3B are flowcharts illustrating exemplary operations for constructing a weighted dependency graph to represent dependencies among a plurality of workloads, according to some aspects;

FIGS. 4A-4G are block diagrams illustrating a weighted dependency graph constructed according to the exemplary operations described in FIGS. 3A and 3B;

FIGS. 5A-5C are flowcharts illustrating exemplary operations for performing a topological sort to linearize the weighted dependency graph illustrated in FIGS. 4A-4G, according to some aspects;

FIGS. 6A-6H are block diagrams illustrating the results of the exemplary operations of FIGS. 5A-5C on the weighted dependency graph illustrated in FIGS. 4A-4G to generate a workflow execution order;

FIGS. 7A and 7B are flowcharts illustrating exemplary operations by software and/or hardware elements of the processor-based device of FIG. 1 for reordering workloads to improve concurrency across threads; and

FIG. 8 is a block diagram of an exemplary processor-based device that can include the processor-based device of FIG. 1.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include reordering workloads to improve concurrency across threads in processor-based devices. Related apparatus, methods, and computer-readable media are also disclosed. In this regard, in some exemplary aspects disclosed herein, a processor-based device (e.g., using a workload execution reordering circuit of a graphics processing unit (GPU), or by executing a driver or other software comprising a workload execution reordering process) receives a plurality of workloads from a requestor, such as an application or Application Programming Interface (API). The processor-based device constructs a weighted dependency graph based on the plurality of workloads, wherein the weighted dependency graph comprises a plurality of vertices that each correspond to a workload of the plurality of workloads, and further comprises one or more directed edges that each connects two of the vertices and indicates a dependency between a corresponding two workloads. In some aspects, a directed edge that represents a cross-thread dependency may be associated with an edge weight that is derived based on a distance between the two vertices. Some aspects may generate a vertex weight for each vertex corresponding to a workload that is independent of a cross-thread dependency. After generating the weighted dependency graph, the processor-based device performs a topological sort of the weighted dependency graph (e.g., based on the edge weights and/or the vertex weights, if applicable). Some aspects may provide that the processor-based device may assign a vertex priority to each vertex of the plurality of vertices, and process the plurality of vertices in an order indicated by the vertex priority of each vertex. Finally, the processor-based device generates a workload execution order based on the topological sort. According to some aspects, the processor-based device may use the generated workload execution order to schedule an independent workload among the plurality of workloads to execute during idle time between two dependent workloads among the plurality of workloads. In this manner, concurrency among threads may be maximized through the more efficient use of processor resources.

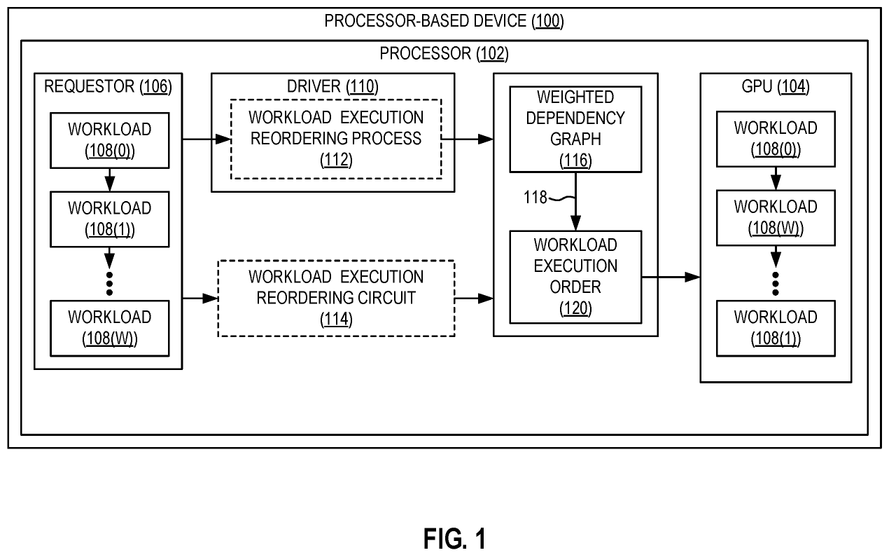

In this regard, FIG. 1 is a block diagram of an exemplary processor-based device 100 comprising a processor 102. The processor 102, which also may be referred to as a “processor core” or a “central processing unit (CPU) core,” may be an in-order or an out-of-order processor (OoP), and/or may be one of a plurality of processors 102 provided by the processor-based device 100. In the example of FIG. 1, the processor 102 comprises a graphics processing unit (captioned as “GPU” in FIG. 1) 104, which comprises dedicated processing circuit for handling the rendering of graphics and/or video data for display. The processor 102 of FIG. 1 is also executing a requestor 106, which may comprise a software application or an API that submits workloads representing graphics and/or video data for processing by the GPU 104.

The processor-based device 100 of FIG. 1 may encompass any one of known digital logic elements, semiconductor circuits, processing cores, and/or memory structures, among other elements, or combinations thereof. Aspects described herein are not restricted to any particular arrangement of elements, and the disclosed techniques may be easily extended to various structures and layouts on semiconductor dies or packages. It is to be understood that some aspects of the processor-based device 100 may include elements in addition to those illustrated in FIG. 1, and/or may include more or fewer of the elements illustrated in FIG. 1. For example, the processor-based device 100 may further include one or more CPUs, processor cores, caches, controllers, communications buses, and/or persistent storage devices, which are omitted from FIG. 1 for the sake of clarity.

As seen in FIG. 1, the requestor 106 has generated a plurality of workloads 108(0)-108(W) to send to the GPU 104, with each workload comprising, e.g., a sequence of graphics instructions and/or operations for generating an image or video. A conventional GPU would receive the workloads 108(0)-108(W) and would process each of workloads 108(0)-108(W) in sequence using a visualization thread and a render thread, with work proceeding in each thread concurrently when possible. However, cross-thread dependencies (i.e., dependencies between workloads in different threads) that may exist between the workloads 108(0)-108(W) may result in a stall in one thread while a workload waits for completion of another workload in the other thread. For example, if the visualization operations for the workload 108(1) depends on the results of the rendering operations for the workload 108(0), but the rendering thread does not complete its processing of the workload 108(0) quickly enough, the visualization thread would have to stall processing of the workload 108(0). This results in wasted GPU processor resources and negatively impacts the performance of the GPU 104.

Accordingly, in this regard, the processor-based device 100 is configured to provide reordering of workloads to improve concurrency across threads. In some aspects, the processor 102 may be configured to execute a driver 110 that comprises a workload execution reordering process 112 that performs the operations described herein for reordering workloads. Some aspects may provide that the processor 102 comprises a workload execution reordering circuit 114 that embodies logic for performing the operations described herein for reordering workloads. In such aspects, the workload execution reordering circuit 114 may be implemented as a separate element as shown in FIG. 1 or may be integrated into the GPU 104. For example, the workload execution reordering circuit 114 may be an element of a command processor (CP) (not shown) of the GPU 104 and may receive information necessary for operation as a preamble to a command buffer (not shown).

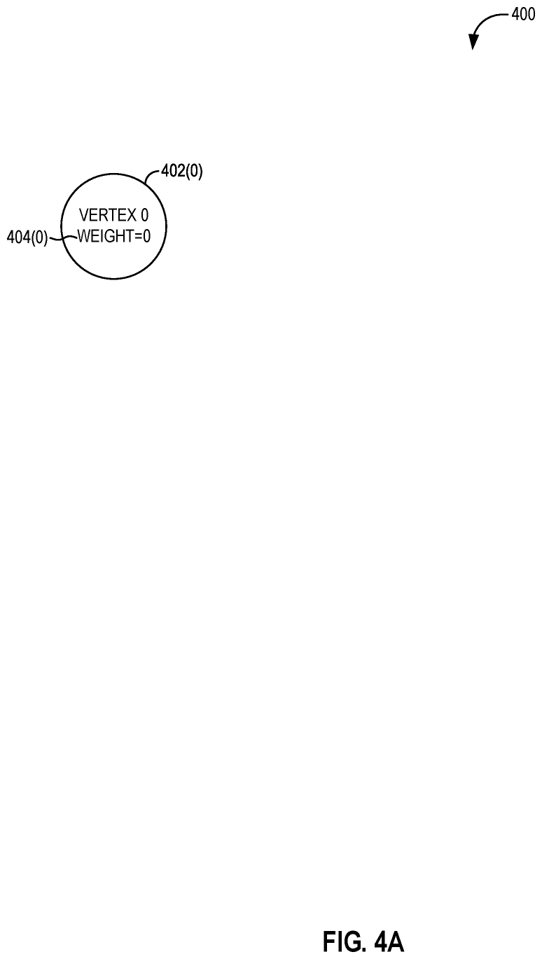

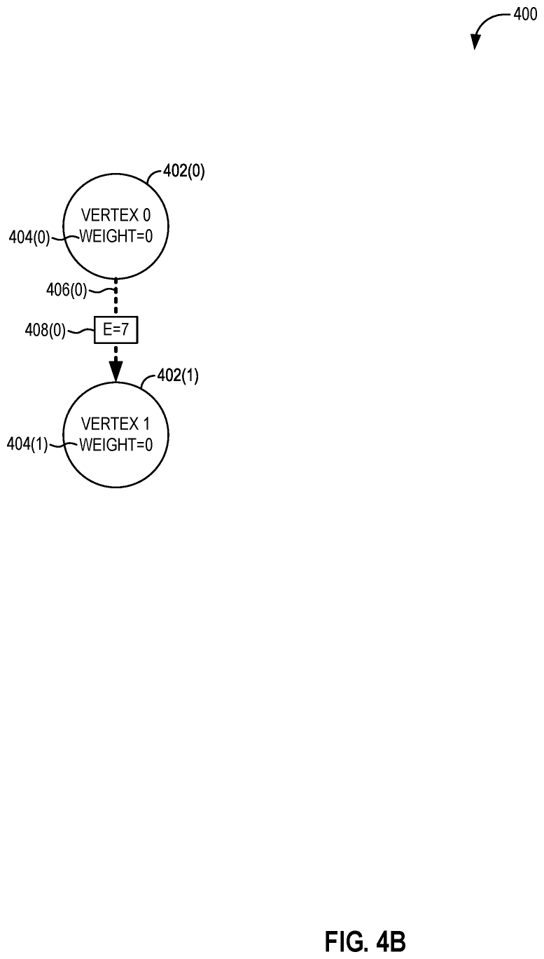

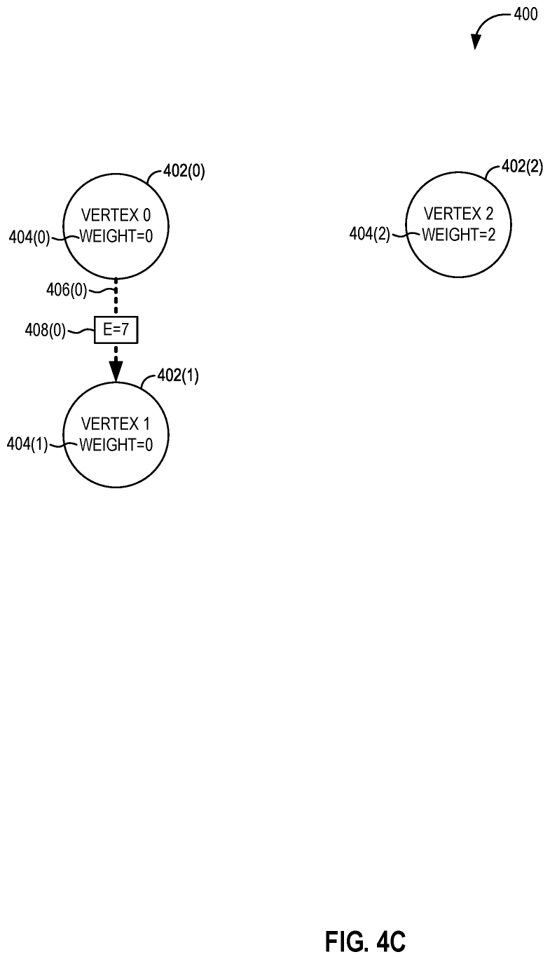

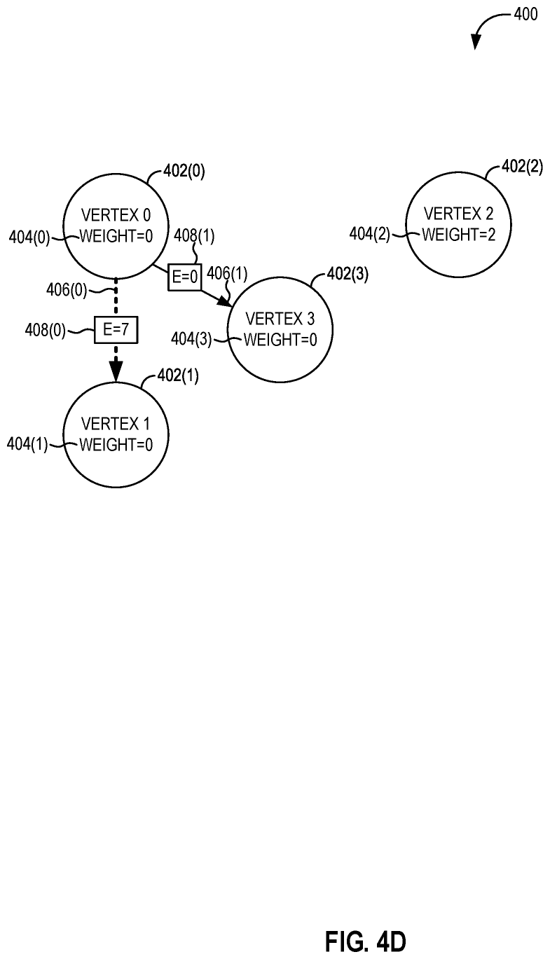

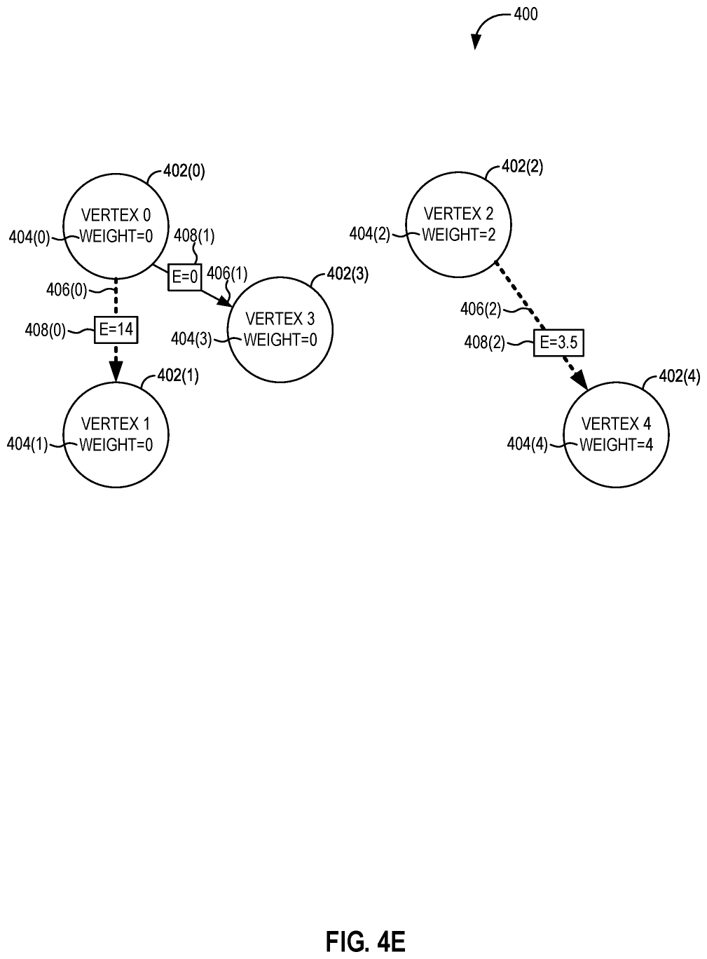

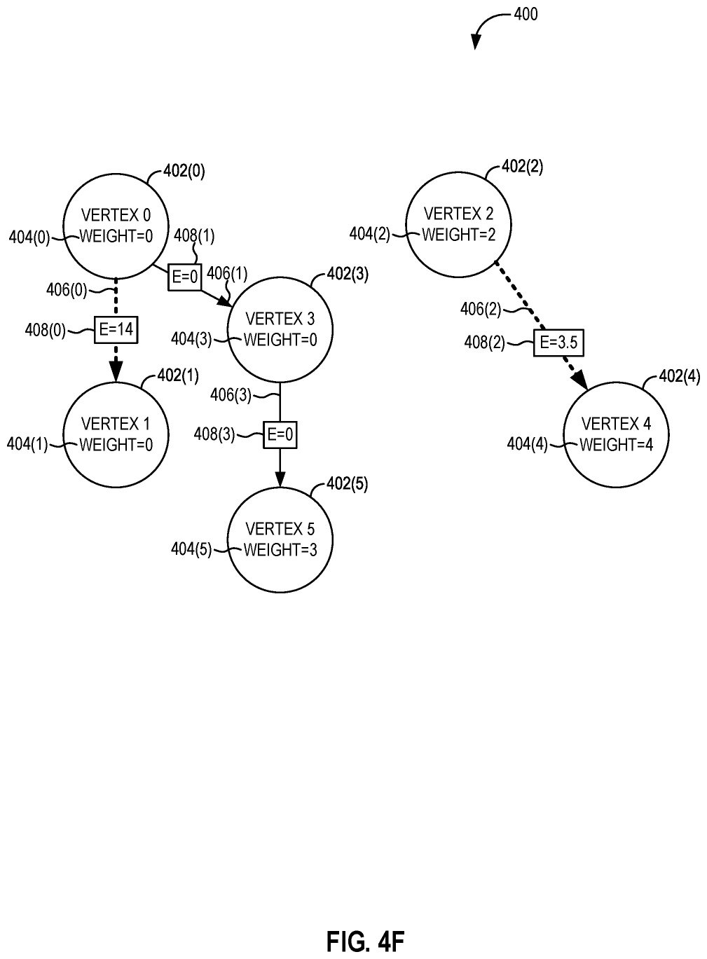

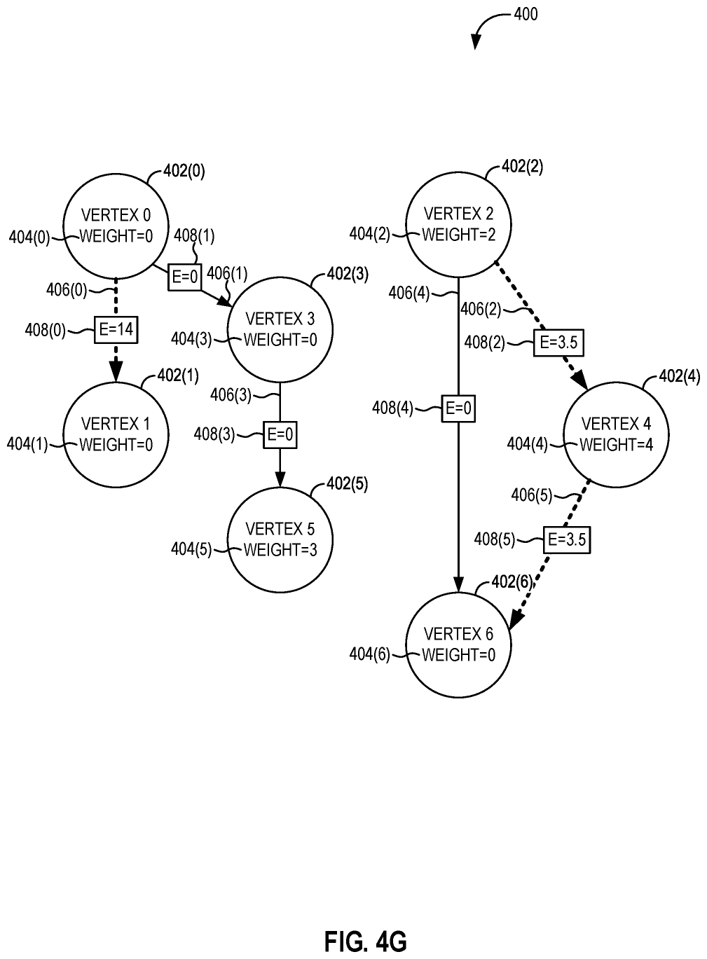

In exemplary operation, the processor 102 (e.g., by executing the workload execution reordering process 112 or by using the workload execution reordering circuit 114) receives the workloads 108(0)-108(W) from the requestor 106, and constructs a weighted dependency graph 116 based on the plurality of workloads 108(0)-108(W). As illustrated in greater detail below with respect to FIGS. 4A-4G, the weighted dependency graph 116 comprises a plurality of vertices (not shown) that each is a point corresponding to a workload of the plurality of workloads 108(0)-108(W), and further comprises one or more directed edges that each connects two of the vertices and indicates a dependency between a corresponding two workloads. The weighted dependency graph 116 in some aspects may comprise a Directed Acyclic Graph (DAG) (i.e., a directed graph with no directed cycles).

After generating the weighted dependency graph 116, the processor 102 performs a topological sort of the weighted dependency graph 116, as indicated by arrow 118, to linearize the weighted dependency graph 116. As used herein, a “topological sort” refers to a linear ordering of the vertices of the weighted dependency graph 116 such that, for every directed edge uv from vertex u to vertex v, u comes before v in the ordering. The topological sort may be based, e.g., on Kahn's sorting algorithm, as a non-limiting example. Finally, the processor 102 generates a workload execution order 120 based on the topological sort. The GPU 104 of the processor 102 then uses the workload execution order 120 to schedule the workloads 108(0)-108(W) in an order that may improve concurrency across thread. As seen in FIG. 1, the workload execution order 120 reorders the workloads 108(0)-108(W) so that the workload 108(W), which in this example lacks any dependencies on other workloads and thus is considered “independent,” is executed before the workload 108(1).

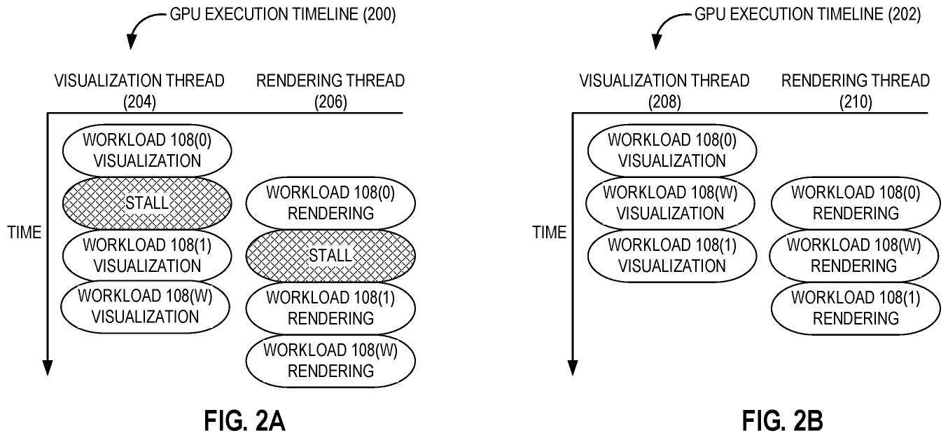

To illustrate how reordering the workloads 108(0)-108(W) may improve concurrency by reducing the occurrence of stalls during execution threads, FIGS. 2A and 2B provide GPU execution timelines 200 and 202, respectively. The GPU execution timeline 200 representing conventional execution of the workloads 108(0)-108(W) in their original sequence and the GPU execution timeline 202 representing execution of the workloads 108(0)-108(W) according to the workload execution order 120 of FIG. 1. The GPU execution timeline 200 shows columns representing a visualization thread 204 and a rendering thread 206, while the GPU execution timeline 202 shows columns representing a visualization thread 208 and a rendering thread 210.

It is assumed for FIGS. 2A and 2B that a cross-thread dependency exists between the visualization phase of the workload 108(1) and the rendering phase of the workload 108(0), while the workload 108(W) does not depend on any other workload and thus is independent. Accordingly, as seen in the GPU execution timeline 200 of FIG. 2A, after the visualization thread 204 completes the workload 108(0) visualization and the rendering thread 206 begins the workload 108(0) rendering, the visualization thread 204 is unable to begin the workload 108(1) visualization until the rendering thread 206 completes the workload 108(0) rendering (due to the dependency between the workload 108(1) visualization and the 108(0) rendering). Consequently, the visualization thread 204 must stall. Likewise, once the rendering thread 206 completes the workload 108(0) rendering, the rendering thread 206 cannot begin the workload 108(1) rendering until the visualization thread 204 completes the workload 108(1) visualization. As a result, the rendering thread 206 must stall.

In contrast, in the GPU execution timeline 202 in FIG. 2B, the sequence of workload execution has been changed so that the independent workload 108(W) is executed between the workload 108(0) and the workload 108(1). This is because, as shown in the original order of the workloads 108(0)-108(W) in FIG. 2A, the workload 108(1) cannot be visualized until the workload 108(0) is rendered due to the cross-thread dependency between the workloads 108(0) and 108(1). Reordering the sequence of workload execution thus results in greater concurrency and shorter overall execution time, as the visualization thread 208 and the rendering thread 210 can execute the workload 108(W) visualization and the workload 108(W) rendering, respectively, during the time that the threads would have otherwise stalled.

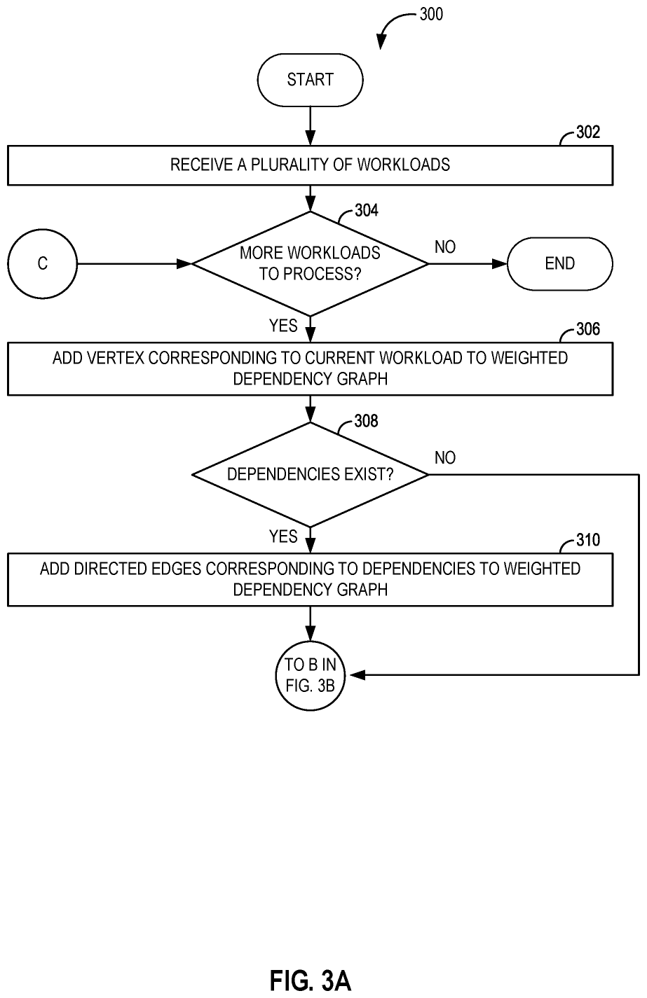

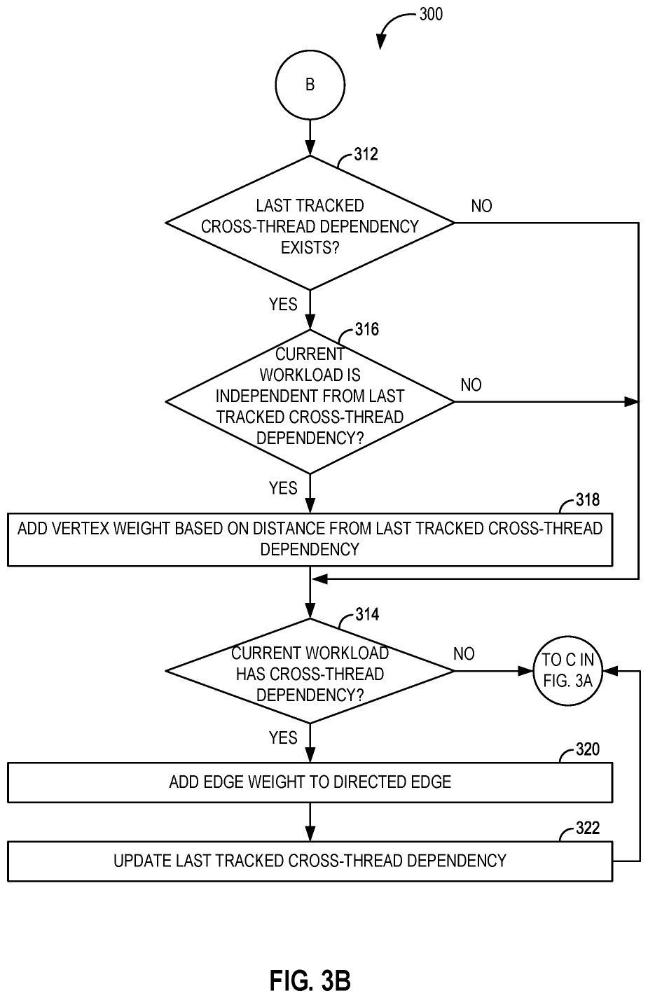

To reorder the sequence of workloads shown in FIG. 2B such that the workload 108(W) is executed before the workload 108(1), the cross-thread dependency between the workload 108(0) and the workload 108(1) is determined and processed. In one example discussed below, this cross-thread dependency is determined and tracked by constructing a weighted dependency graph to represent dependencies among a plurality of workloads according to some aspects. In this regard, to illustrate exemplary operations for constructing a weighted dependency graph comprising a DAG to represent dependencies among a plurality of workloads according to some aspects, FIGS. 3A and 3B are provided. FIGS. 3A and 3B provide flowcharts that illustrate an exemplary process 300 for constructing a weighted dependency graph. In the example process 300 of FIGS. 3A and 3B, it is assumed that workloads are processed in an order specified by the requestor (e.g., the requestor 106 of FIG. 1). Results of performing the operations of the process 300 of FIGS. 3A and 3B on an exemplary plurality of workloads are illustrated and discussed in greater detail below with respect to FIGS. 4A-4G.

In FIG. 3A, operations of the process 300 begin with a processor (e.g., the processor 102 of FIG. 1 executing the workload execution reordering process 112 or by using the workload execution reordering circuit 114) receiving a plurality of workloads (e.g., the plurality of workloads 108(0)-108(W) of FIG. 1) (block 302). The processor 102 determines whether more workloads exist to process (block 304). If no more workloads require processing, operations end. However, if the processor 102 determines at decision block 304 that there are more workloads to process, the processor 102 adds a vertex corresponding to the current workload to the weighted dependency graph (block 306). The processor 102 then determines whether any dependencies exist between the current workload and a previous workload (block 308). If not, operations continue at block 312 of FIG. 3B. If the processor 102 determines at decision block 308 that dependencies exist, the processor 102 adds directed edges corresponding to the dependencies to the weighted dependency graph (block 310). Operations then continue at block 312 in FIG. 3B.

Turning now to FIG. 3B, the process 300 continues with the processor 102 next determining whether a last tracked cross-thread dependency exists (i.e., whether a cross-thread dependency was previously encountered and tracked by, e.g., setting a last tracked cross-thread dependency indicator) (block 312). If no last tracked cross-thread dependency exists, operations resume at block 314 of FIG. 3B. However, if the processor 102 determines at decision block 312 that a last tracked cross-thread dependency does exist, the processor 102 determines whether the current workload is independent from the last tracked cross-thread dependency (block 316). If not, operations resume at block 314 of FIG. 3B. If the processor 102 determines at decision block 316 that the current workload is independent from the last tracked cross-thread dependency, the processor 102 adds a vertex weight to the vertex, based on the distance from the last tracked cross-thread dependency (block 318).

The processor 102 next determines whether the current workload has a cross-thread dependency (block 314). If not, operations resume at block 304 of FIG. 3A. However, if the processor 102 determines at decision block 314 that the current workload has a cross-thread dependency, the processor 102 adds an edge weight to the directed edge representing the cross-thread dependency (block 320). The processor 102 also update the last tracked cross-thread dependency (i.e., to indicate the current workload as the last encountered cross-thread dependency) (block 322). Operations then resume at block 304 of FIG. 3A.

FIGS. 4A-4G illustrate the construction of a weighted dependency graph 400 according to the exemplary process 300 described in FIGS. 3A and 3B. It is assumed for the sake of illustration that a plurality of workloads 108(0)-108(6) (i.e., the plurality of workloads 108(0)-108(W) of FIG. 1, where W=6) are received from a requestor, such as the requestor 106 of FIG. 1. As seen in FIG. 4A, a vertex 402(0) is added to the weighted dependency graph 400 to represent the workload 108(0), the first workload that is processed from the requestor 106. Because the workload 108(0) is the first, there is no other workload on which it depends. The vertex 402(0) is assigned a vertex weight 404(0) of zero (0).

In FIG. 4B, processing the workload 108(1) results in a vertex 402(1) being added to the weighted dependency graph 400. The processor 102 determines, based on dependency information, that the workload 108(1) has a cross-thread dependency on the workload 108(0), and consequently a directed edge 406(0) associated with an edge weight 408(0) is added between the vertex 402(0) and the vertex 402(1). The edge weight 408(0) is set to a value of seven (7), which in this example is determined by dividing the total number of workloads (i.e., 7) by the logical distance between the vertex 402(0) and the vertex 402(1) (i.e., 1). The vertex 402(1) is assigned a vertex weight 404(1) of zero (0). Additionally, the last tracked cross-thread dependency (not shown) is set to indicate the vertex 402(0).

In FIG. 4C, the processing of the workload 108(2) results in a vertex 402(2) being added to the weighted dependency graph 400. The processor 102 determines, based on dependency information, that the workload 108(2) does not depend on any other workloads. Because the workload 108(2) is independent of the last tracked cross-thread dependency, the vertex 402(2) assigned a vertex weight 404(2) of two (2), which is determined based on the logical distance between the vertex 402(2) and the last tracked cross-thread dependency (i.e., the vertex 402(0)).

In FIG. 4D, a vertex 402(3) is added to the weighted dependency graph 400 to represent the workload 108(3). The processor 102 determines that the workload 108(3) has an intra-thread dependency on the workload 108(0), and thus adds a directed edge 406(1). Because the dependency is not a cross-thread dependency, the directed edge is unweighted (i.e., is assigned an edge weight 408(1) of zero (0)). The vertex 402(3) depends on the last tracked cross-thread dependency (i.e., the vertex 402(0)), so the vertex weight 404(3) of the vertex 402(3) is set to zero (0).

In FIG. 4E, the workload 108(4) is processed, resulting in a vertex 402(4) being added to the weighted dependency graph 400. The processor 102 determines that the workload 108(4) has a cross-thread dependency on the workload 108(2), and thus adds a directed edge 406(2) with an edge weight 408(2) of 3.5 (i.e., the total number of workloads (7) divided by the logical distance between the vertex 402(4) and the vertex 402(2), which is 2). Because the vertex 402(4) is also independent of the last tracked cross-thread dependency (i.e., the vertex 402(0)), the vertex 402(4) is assigned a vertex weight 404(4) with a value of four (4) (i.e., the logical distance between the vertex 402(4) and the vertex 402(0)). Finally, because the vertex 402(4) has a cross-thread dependency on the vertex 402(2), the last tracked cross-thread dependency is updated to indicate the vertex 402(2).

In FIG. 4F, processing of the workload 108(5) results in a vertex 402(5) being added to the weighted dependency graph 400. The processor 102 determines that the vertex 402(5) has an intra-thread dependency on the vertex 402(3). Accordingly, a directed edge 406(3) is added from the vertex 402(3) to the vertex 402(5), with an edge weight 408(3) of zero (0). Because the vertex 402(5) is independent of the last tracked cross-thread dependency (i.e., the vertex 402(2)), the vertex 402(5) is assigned a vertex weight 404(5) with a value of three (3) (i.e., the logical distance between the vertex 402(5) and the vertex 402(2)).

Finally, in FIG. 4G, a vertex 402(6) is added to represent the workload 108(6). The processor 102 determines that the workload 108(6) depends on both the workload 108(2) and the workload 108(4). The dependency on the workload 108(2) is an intra-thread dependency, so a directed edge 406(4) is added with an edge weight 408(4) of zero (0). The workload 108(6) has a cross-thread dependency on the workload 108(4), so a directed edge 406(5) is added with an edge weight 408(5) of 3.5 (i.e., the total number of workloads (7) divided by the logical distance between the vertex 402(6) and the vertex 402(4), which is 2). Note that because the vertex 402(6) is independent of the last tracked cross-thread dependency (i.e., the vertex 402(2)), the vertex 402(6) is assigned a vertex weight 404(6) of zero (0).

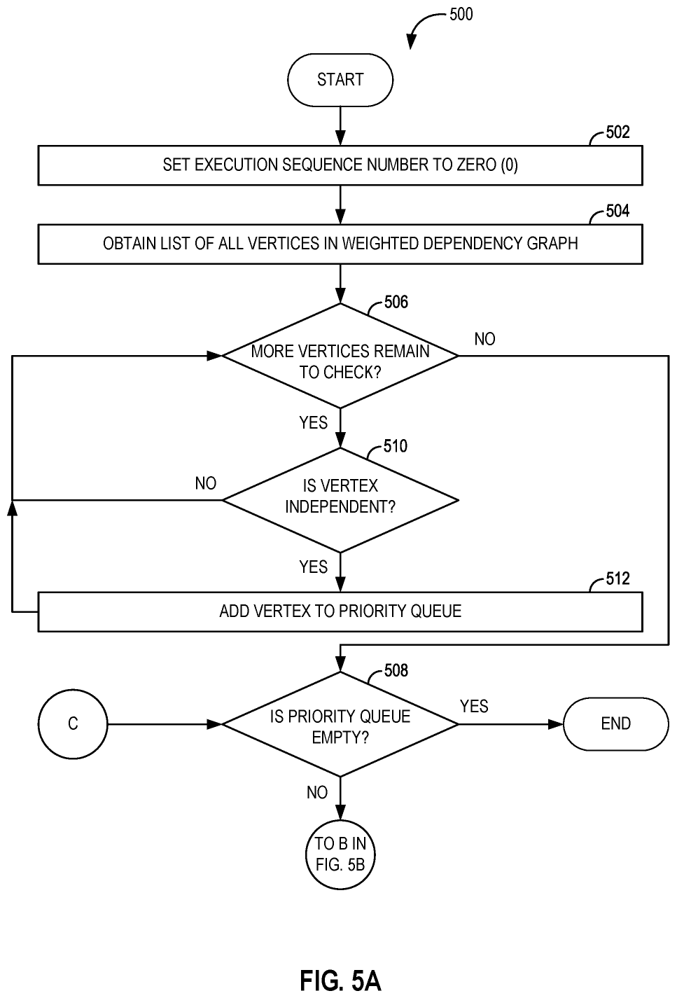

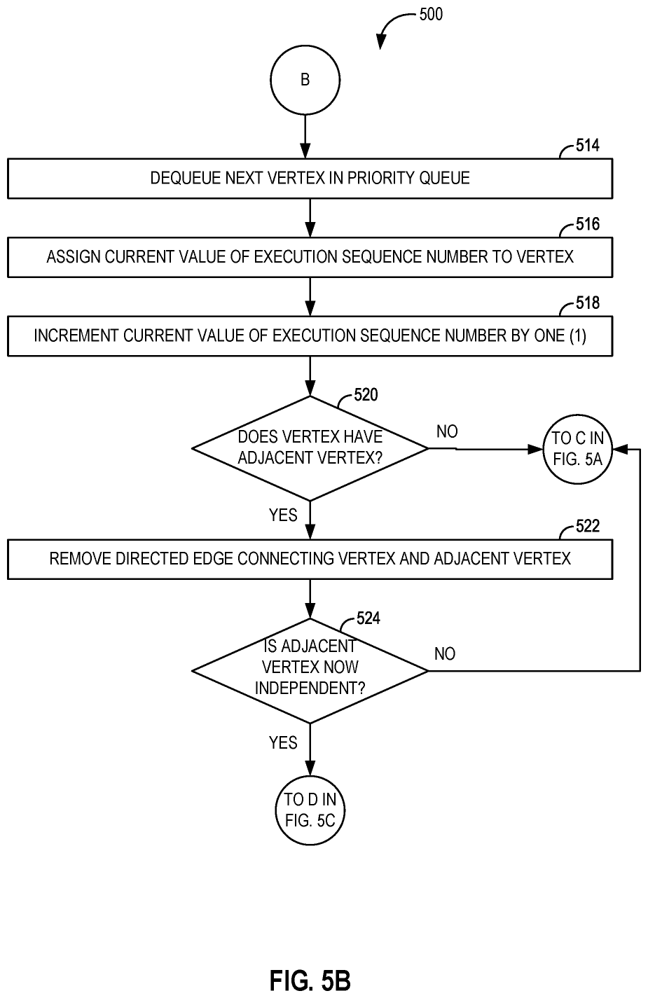

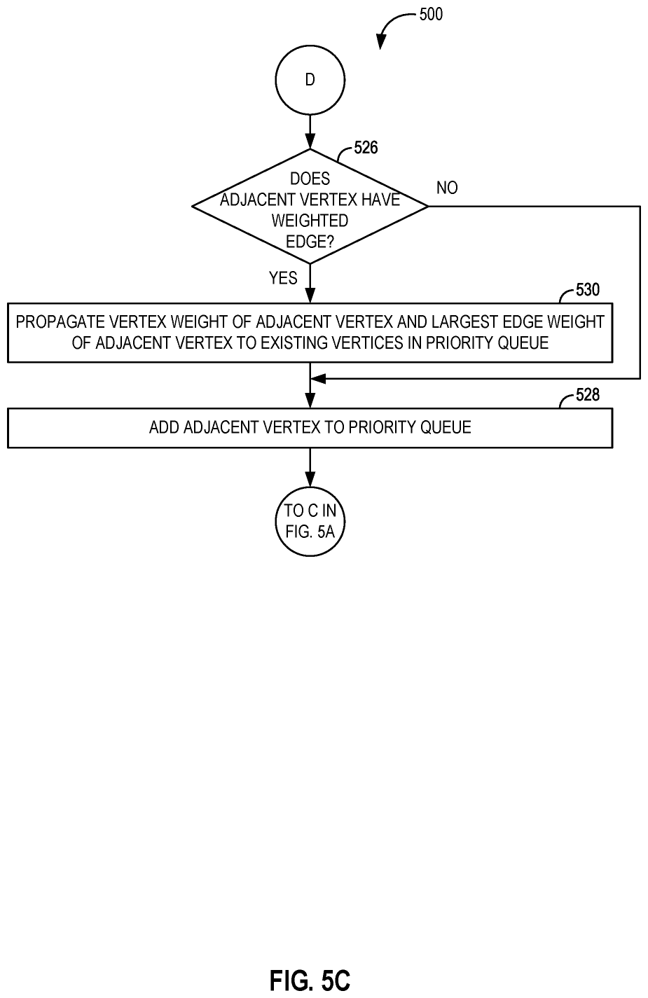

To illustrate exemplary operations for performing a topological sort to linearize the weighted dependency graph 400 illustrated in FIGS. 4A-4G according to some aspects, FIGS. 5A-5C are flowcharts that illustrate an exemplary process 500 for sorting the weighted dependency graph 400. Operations of the process 500 begin in FIG. 5A with a processor (e.g., the processor 102 of FIG. 1 executing the workload execution reordering process 112 or by using the workload execution reordering circuit 114) setting an execution sequence number to zero (0) (block 502). As execution sequence is determined, the current value of the execution sequence is assigned to each workload to indicate its place in the generated workload execution sequence.

The processor 102 next obtains list of all vertices 402(0)-402(6) in the weighted dependency graph 400 (block 504). The processor 102 determines whether more vertices exist to check (block 506). If not, operations resume at block 508 of FIG. 5A. However, if the processor 102 determines at decision block 506 that more vertices exist, the processor 102 determines whether the current vertex is independent (block 510). If not, operations resume at block 506 of FIG. 5A. If the processor 102 determines that the current vertex is independent, the processor 102 adds the vertex to a priority queue (block 512). The processor 102 then determines whether the priority queue is empty (block 508). If so, processing ends. If not, operations continue at block 514 of FIG. 5B.

Turning now to FIG. 5B, the process 500 continues with the processor 102 dequeuing a next vertex in the priority queue (block 514). The processor 102 assigns a current value of the execution sequence number to the vertex (block 516). The processor 102 then increments the current value of the execution sequence number by one (1) (block 518). Next, the processor 102 determines whether the vertex has an adjacent vertex (block 520). If not, operations return to block 508 of FIG. 5A. However, if the processor 102 determines at decision block 520 that the vertex has an adjacent vertex, the processor 102 removes the directed edge connecting the vertex and the adjacent vertex (block 522). The processor 102 determine whether the adjacent vertex is now independent (block 524). If not, operations return to block 508 of FIG. 5A. If the processor 102 determines that the adjacent vertex is now independent, operations continue at block 526 of FIG. 5C.

Referring now to FIG. 5C, the process 500 continues with the processor 102 determining whether the adjacent vertex has a weighted edge (block 526). If not, operations continue at block 528 of FIG. 5C. If the adjacent vertex is determined to have a weighted edge at decision block 528, the processor 102 propagates the vertex weight of the adjacent vertex and the largest edge weight of the adjacent vertex to existing vertices in the priority queue (block 530). The processor 102 then adds the adjacent vertex to the priority queue (block 528). Operations then return to block 508 in FIG. 5A.

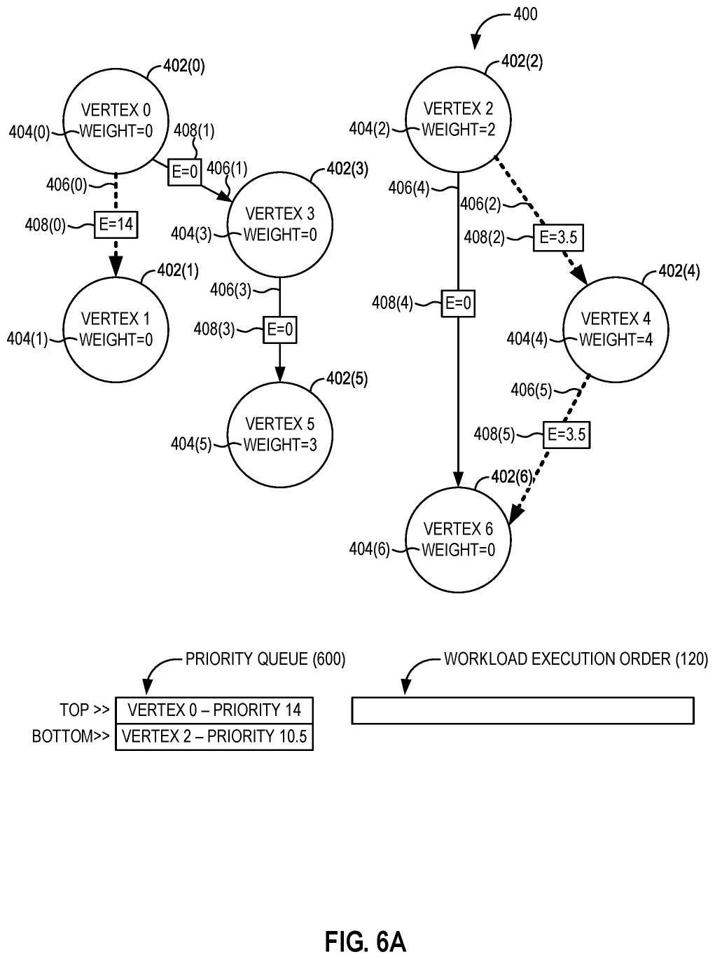

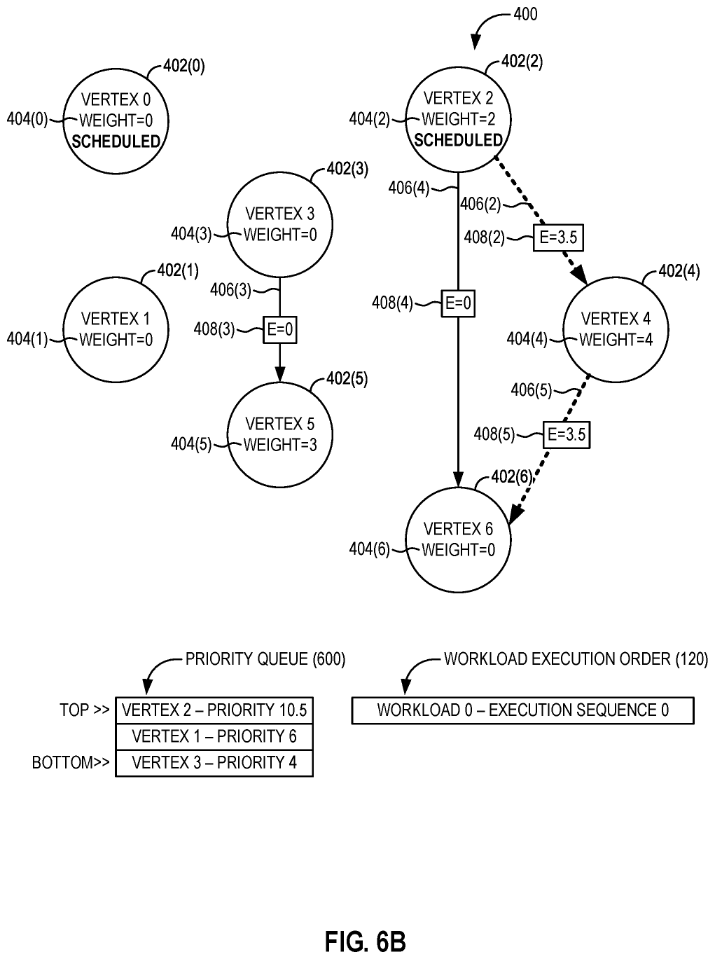

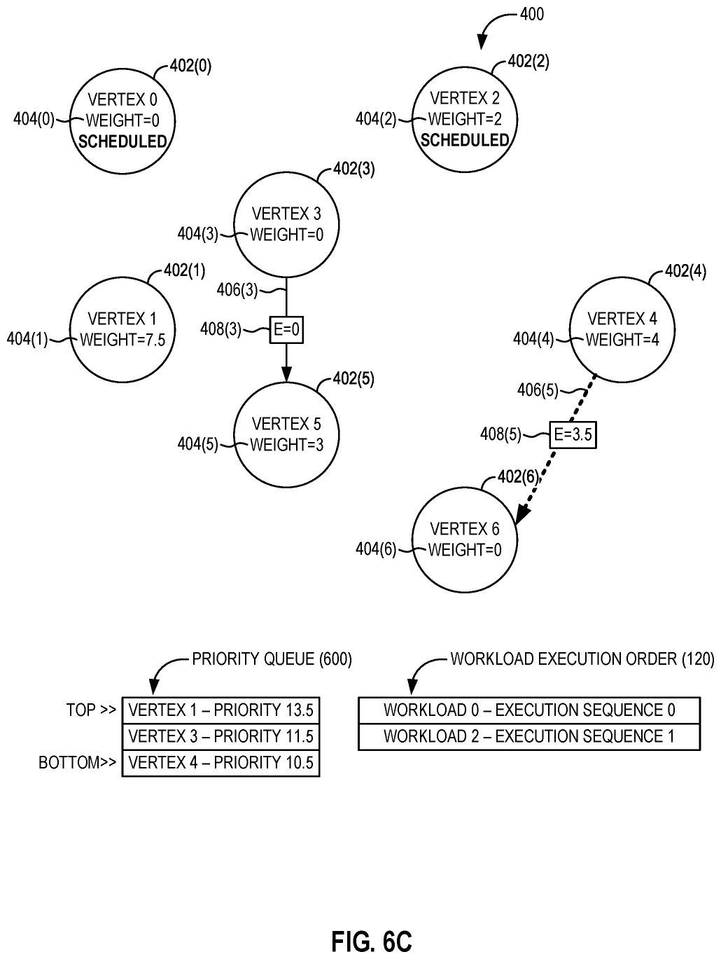

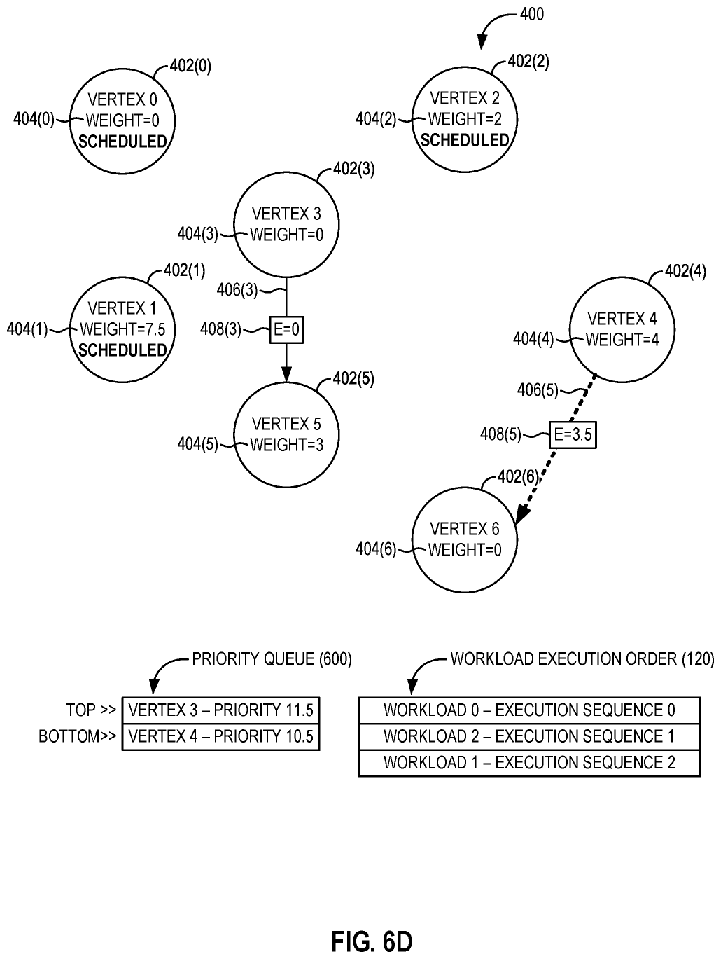

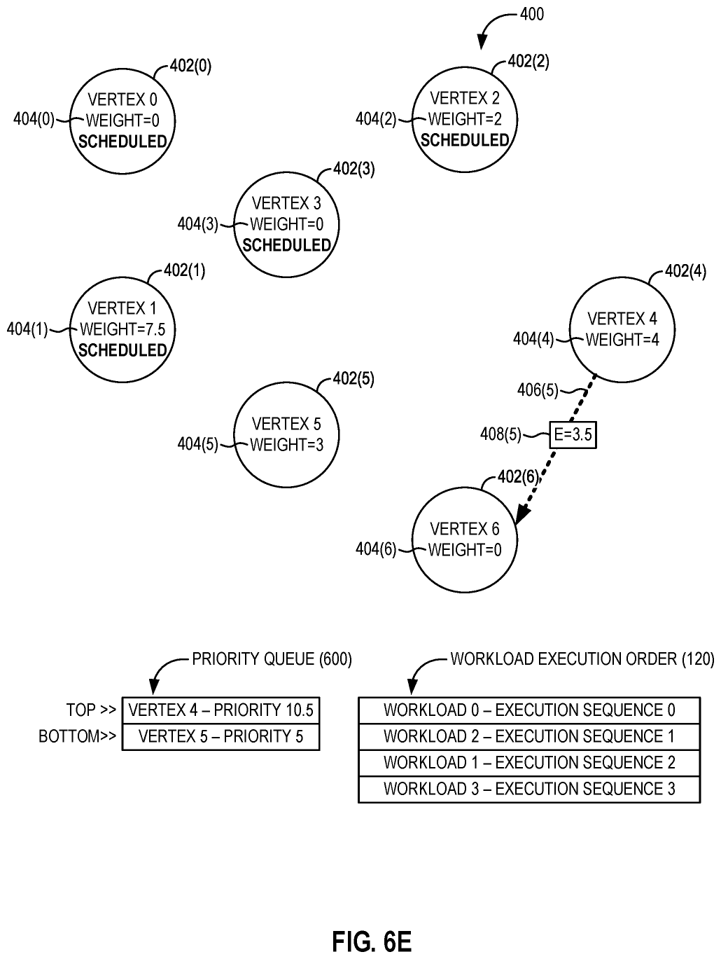

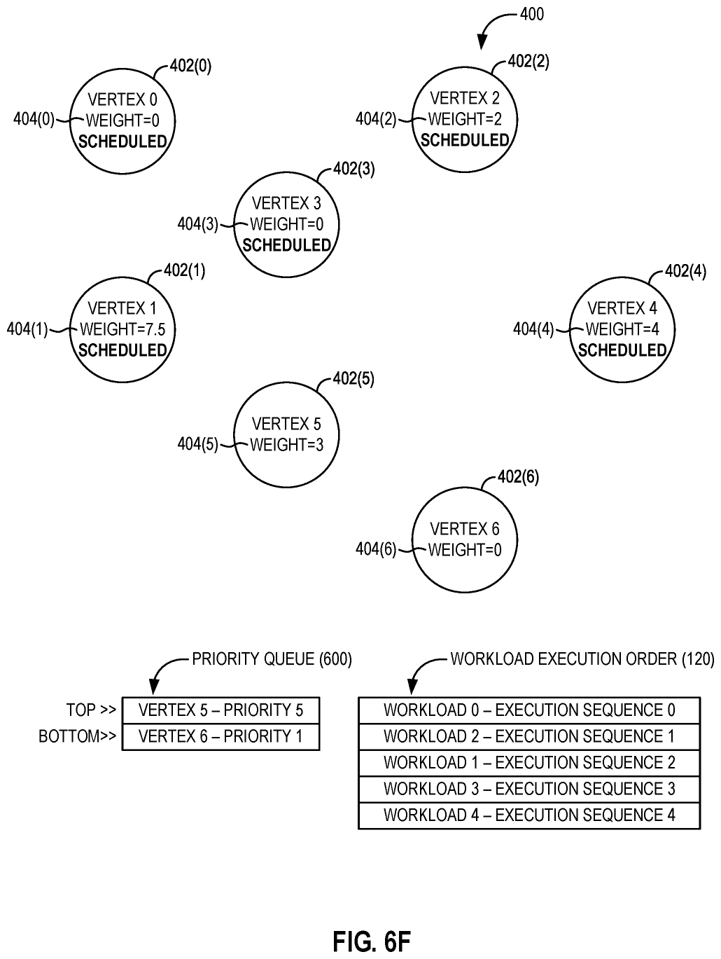

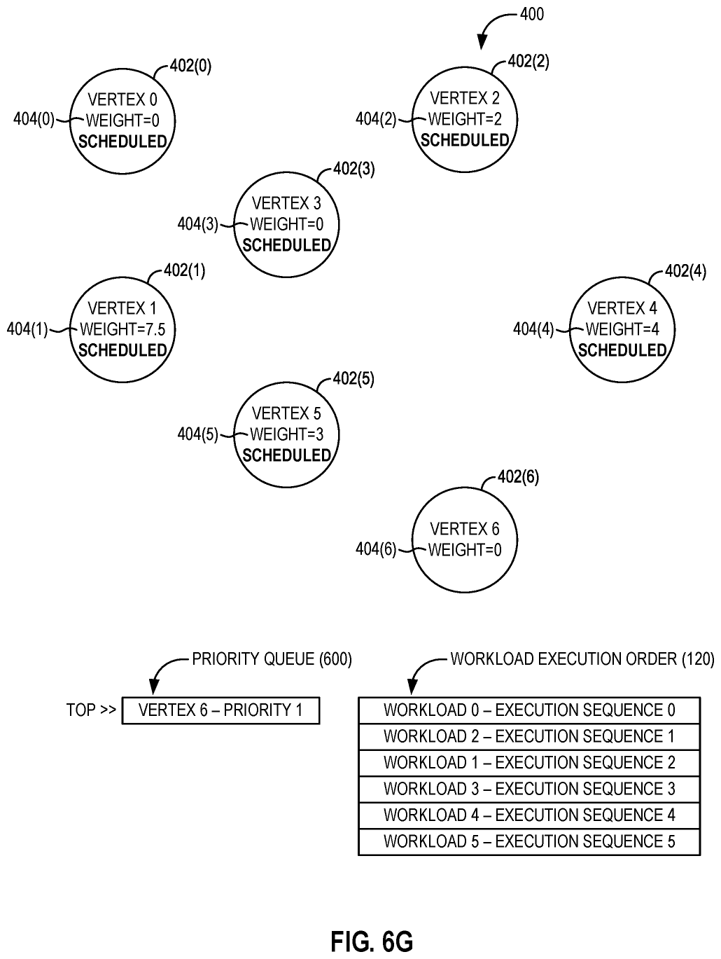

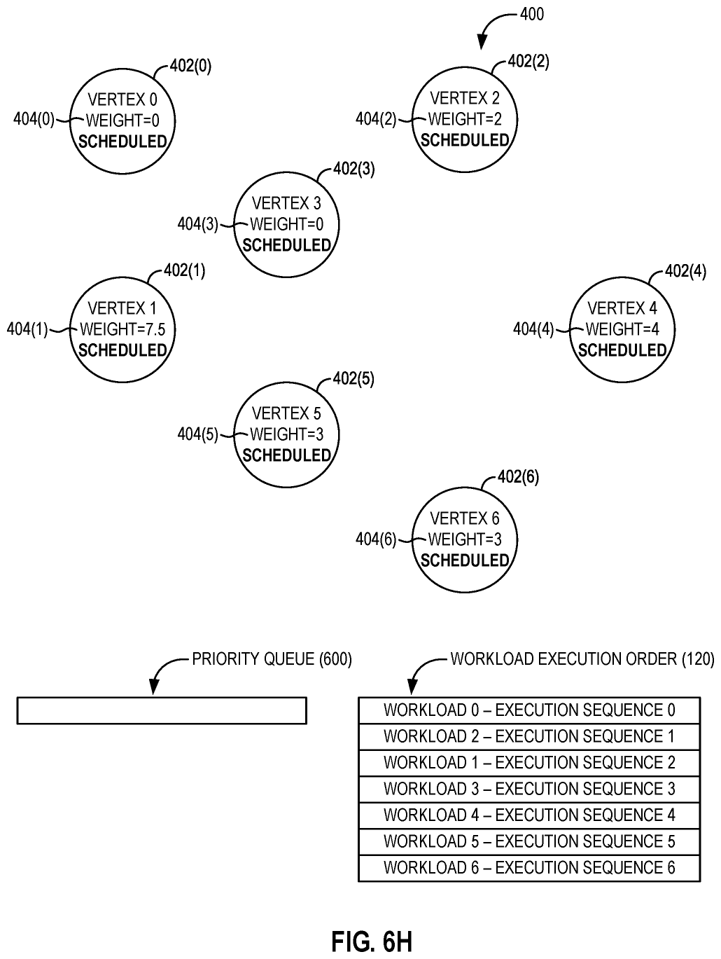

The results of the exemplary operations of FIGS. 5A-5C to perform a topological sort of the weighted dependency graph 400 illustrated in FIGS. 4A-4G and generate a workflow execution order are shown in FIGS. 6A-6H. As the weighted dependency graph 400 is processed, FIGS. 6A-6H show the effects on a priority queue 600 and a workload execution order 120. To determine the priority in which the vertices 402(0)-402(6) of the weighted dependency graph 400 are to be processed, a vertex priority P may be generated using the following equation, where V is the set of a numeric vertex identifier V1, a vertex weight V2, and an edge weight V3, and N is a total number of vertices in a graph G:

P(V)=(N−V1)+V2+V3

In FIG. 6A, a breadth-first search of all independent vertices among the vertices 402(0)-402(6) is performed. The vertex 402(0) and the vertex 402(2) have no dependencies, so they are added to the priority queue 600. The vertex priority of the vertex 402(0) is calculated as P(V0)=7−0+0+7=14, while the vertex priority of the vertex 402(2) is calculated as P(V2)=(7−2)+2+3.5=10.5. Accordingly, the highest priority vertex is determined to be the vertex 402(0).

In FIG. 6B, the vertex 402(0), the highest priority vertex, is dequeued from the priority queue 600, and an execution sequence number of zero (0) is assigned to the corresponding workload 108(0) in the workload execution order 120. The vertex 402(1) and the vertex 402(3), the vertices adjacent to the vertex 402(0), are processed next. The directed edges 406(0) and 406(1) of FIG. 6A are removed, and because the vertex 402(1) and the vertex 402(3) each have no other edges and now have no dependencies, they are added to the priority queue 600. The vertex priority of the vertex 402(1) is calculated as P(V1)=7−1+0+0=6, while the vertex priority of the vertex 402(3) is calculated as P(V3)=7−3+0+0=4.

In FIG. 6C, the vertex 402(2), the current highest priority vertex, is dequeued from the priority queue 600, and an execution sequence number of one (1) is assigned to the corresponding workload 108(2) in the workload execution order 120. The adjacent vertex 402(4) and the adjacent vertex 402(6) are processed, and the respective directed edges 406(2) and 406(4) of FIGS. 6A-6B are removed from the weighted dependency graph 400. Because the vertex 402(4) is now independent, the processor 102 determines whether the vertex 402(4) has a directed edge with an assigned edge weight. In this case, the vertex 402(4) has a directed edge 406(5) to the vertex 402(6) with an edge weight 408(5) of 3.5, so the vertex weights and vertex priority of all vertices in the priority queue 600 (i.e., the vertex 402(1) and the vertex 402(3)) are updated.

The updated vertex weight 404(1) for the vertex 402(1) is calculated as follows:

W(V1,G)=W(V1)′+W(V4)+E(V4)=0+4+3.5=7.5

The updated vertex priority for the vertex 402(1) is calculated as follows:

P(V1)=P(V1)′+V2+V3=6+4+3.5=13.5

The updated vertex weight 404(3) for the vertex 402(3) is calculated as follows:

W(V3,G)=W(V3)′+W(V4)+E(V4)=0+4+3.5=7.5

The updated vertex priority for the vertex 402(3) is calculated as follows:

P(V3)=P(V3)′+V2+V3=4+4+3.5=11.5

Once the vertex priorities for the vertex 402(1) and the vertex 402(3) are updated, the vertex 402(4) is enqueued in the priority queue 600 because it is now independent. The vertex priority of the vertex 402(4) is calculated as P(V4)=(7−4)+4+3.5=10.5.

In FIG. 6D, the vertex 402(1), the current highest priority vertex, is dequeued from the priority queue 600, and an execution sequence number of two (2) is assigned to the corresponding workload 108(1) in the workload execution order 120. Because there are no directed edges from the vertex 402(1), processing continues to the next vertex in the priority queue 600.

In FIG. 6E, the vertex 402(3), the current highest priority vertex, is dequeued from the priority queue 600, and an execution sequence number of three (3) is assigned to the corresponding workload 108(3) in the workload execution order 120. The adjacent vertex 402(5) is processed, and the directed edge 406(3) of FIGS. 6A-6D from the vertex 402(3) to the vertex 402(5) is removed. Because the vertex 402(5) does not have any outgoing directed edges with an edge weight assigned, no adjustments are made to the priorities of the vertices in the priority queue 600. Additionally, because the vertex 402(5) has no incoming directed edges, the vertex 402(5) is added to the priority queue 600 with a vertex priority calculated as P(V5)=(7−5)+3=5.

In FIG. 6F, the vertex 402(4), the current highest priority vertex, is dequeued from the priority queue 600, and an execution sequence number of four (4) is assigned to the corresponding workload 108(4) in the workload execution order 120. The adjacent vertex 402(6) is processed, and the directed edge 406(5) of FIGS. 6A-6E from the vertex 402(4) to the vertex 402(6) is removed. Because the vertex 402(6) does not have any outgoing directed edges with an edge weight assigned, no adjustments are made to the priorities of the vertices in the priority queue 600. Additionally, because the vertex 402(6) has no incoming directed edges, the vertex 402(6) is added to the priority queue 600 with a vertex priority calculated as P(V6)=(7−6)+0=1.

In FIG. 6G, the vertex 402(5), the current highest priority vertex, is dequeued from the priority queue 600, and an execution sequence number of five (5) is assigned to the corresponding workload 108(5) in the workload execution order 120. Because there are no directed edges from the vertex 402(5), processing continues to the next vertex in the priority queue 600.

Finally, in FIG. 6H, the vertex 402(6), the current highest priority vertex, is dequeued from the priority queue 600, and an execution sequence number of six (6) is assigned to the corresponding workload 108(6) in the workload execution order 120. Because the vertex 402(6) has no outgoing directed edges and the priority queue 600 is now empty, the generation of the workload execution order 120 is complete.

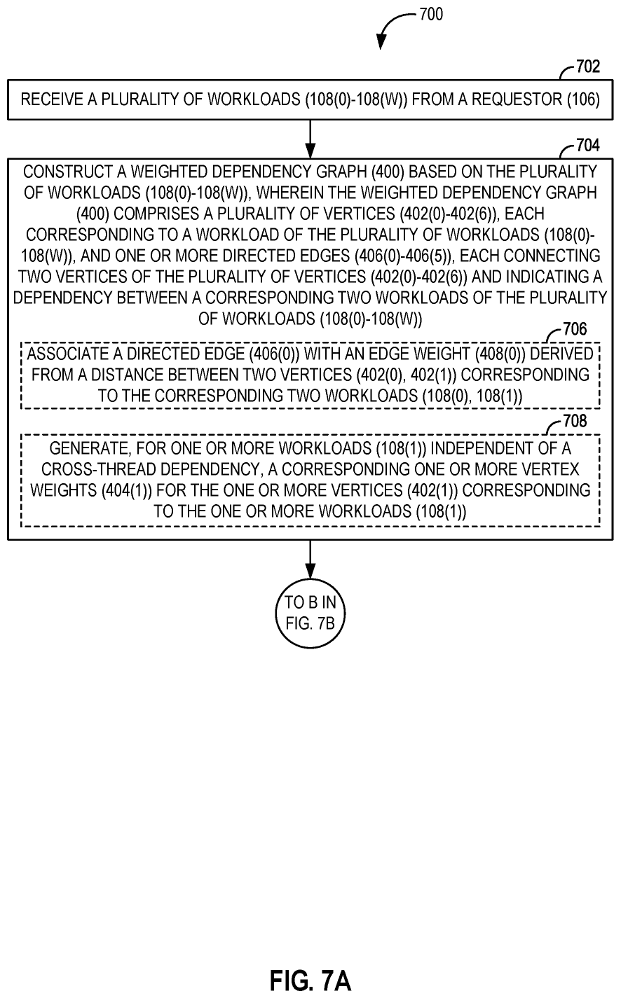

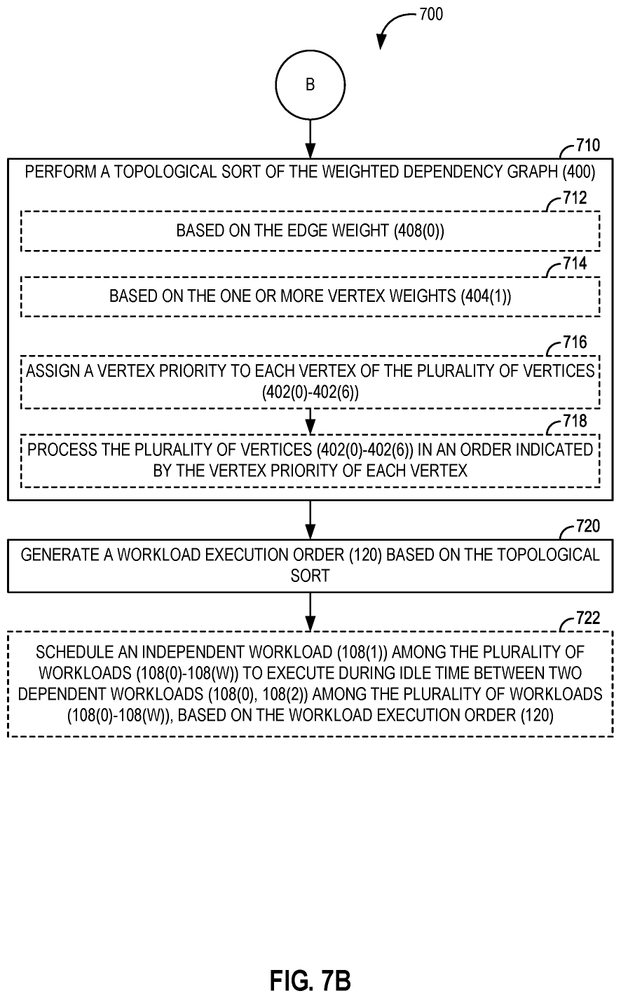

To illustrating exemplary operations by software and/or hardware elements of the processor-based device 100 of FIG. 1 for reordering workloads to improve concurrency across threads, FIGS. 7A and 7B provide a flowchart 700. For the sake of clarity, elements of FIGS. 1, 4A-4G, and 6A-6H are referenced in describing FIGS. 7A and 7B. Operations in FIG. 7 begin with a processor (e.g., the processor 102 of FIG. 1 executing the workload execution reordering process 112 or by using the workload execution reordering circuit 114) receiving a plurality of workloads (e.g., the plurality of workloads 108(0)-108(W) of FIG. 1) from a requestor (e.g., the requestor 106 of FIG. 1) (block 702). The processor 102 constructs a weighted dependency graph (e.g., the weighted dependency graph 400 of FIGS. 4A-4G) based on the plurality of workloads 108(0)-108(W), wherein the weighted dependency graph 400 comprises a plurality of vertices (e.g., the plurality of vertices 402(0)-402(6) of FIGS. 4A-4G), each corresponding to a workload of the plurality of workloads 108(0)-108(W), and one or more directed edges (e.g., the directed edges 406(0)-406(5) of FIGS. 4A-4G), each connecting two vertices of the plurality of vertices 402(0)-402(6) and indicating a dependency between a corresponding two workloads of the plurality of workloads 108(0)-108(W) (block 704).

It is to be understood that, according to some aspects, the operations of block 704 for constructing the weighted dependency graph 400 may be accomplished by performing the operations described and illustrated above with respect to FIGS. 3A and 3B and FIGS. 4A-4G. Accordingly, in some aspects, the operations of block 704 for constructing the weighted dependency graph 400 may comprise associate a directed edge, such as the directed edge 406(0) of FIGS. 4A-4G, with an edge weight (e.g., the edge weight 408(0) of FIGS. 4A-4G) derived from a distance between two vertices 402(0), 402(1) corresponding to the corresponding two workloads 108(0), 108(1) (block 706). Some aspects may provide that the operations of block 704 for constructing the weighted dependency graph 400 may comprise generating, for one or more workloads (e.g., the workload 108(1) of FIGS. 4A-4G) independent of a cross-thread dependency, a corresponding one or more vertex weights (e.g., the vertex weight 404(1) of FIGS. 4A-4G) for the one or more vertices (e.g., the vertex 402(1) of FIGS. 4A-4G) corresponding to the one or more workloads 108(1) (block 708). Operations continue at block 710 of FIG. 7B.

Referring now to FIG. 7B, the processor 102 next performs a topological sort of the weighted dependency graph 400 (block 710). It is to be understood that, according to some aspects, the operations of block 710 for performing the topological sort of the weighted dependency graph 400 may be accomplished by performing the operations described and illustrated above with respect to FIGS. 5A-5C and FIGS. 6A-6H. Thus, in some aspects, the operations of block 710 for performing the topological sort of the weighted dependency graph 400 may be based on the edge weight 408(0) (block 712). Some aspects may provide that the operations of block 710 for performing the topological sort of the weighted dependency graph 400 are based on the one or more vertex weights 404(1) (block 714). According to some aspects, the operations of block 710 for performing the topological sort of the weighted dependency graph 400 may comprise assigning a vertex priority to each vertex of the plurality of vertices 402(0)-402(6) (block 716). The processor 102 then processes the plurality of vertices 402(0)-402(6) in an order indicated by the vertex priority of each vertex (block 718).

The processor 102 then generates a workload execution order (e.g., the workload execution order 120 of FIGS. 1 and 6A-6H) based on the topological sort (block 720). In some aspects, the processor 102 may schedule an independent workload (e.g., the workload 108(1) of FIGS. 1 and 6A-4H) among the plurality of workloads 108(0)-108(W) to execute during idle time between two dependent workloads (e.g., the workloads 108(0), 108(2) of FIGS. 1 and 6A-6H) among the plurality of workloads 108(0)-108(W), based on the workload execution order 120 (block 722).

Reordering workloads to improve concurrency across threads according to aspects disclosed herein may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, laptop computer, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, an avionics system, a drone, and a multicopter.

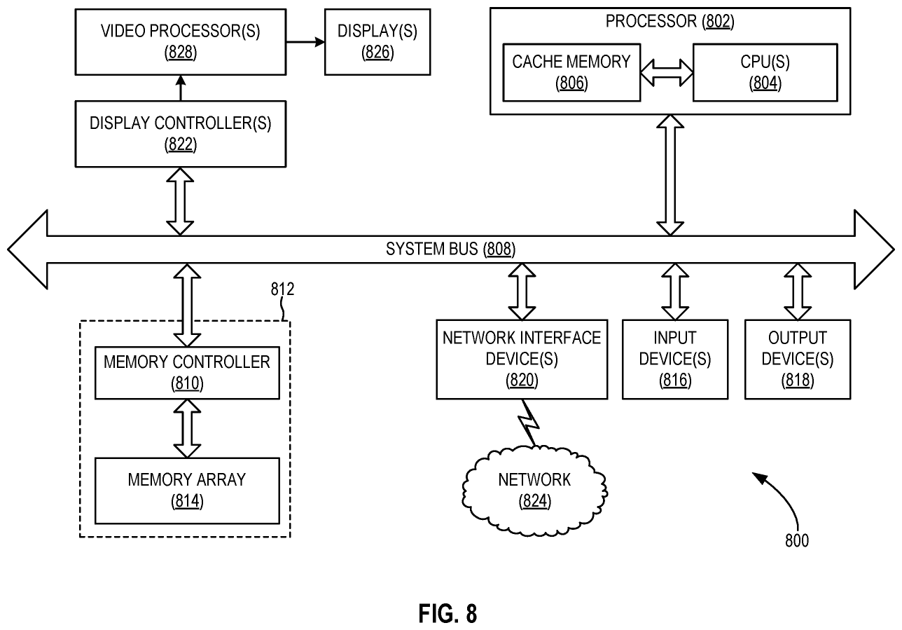

In this regard, FIG. 8 illustrates an example of a processor-based device 800 that may comprise the processor-based device 100 illustrated in FIG. 1. In this example, the processor-based device 800 includes a processor 802 that includes one or more central processing units (captioned as “CPUs” in FIG. 8) 804, which may also be referred to as CPU cores or processor cores. The processor 802 may have cache memory 806 coupled to the processor 802 for rapid access to temporarily stored data. The processor 802 is coupled to a system bus 808 and can intercouple master and slave devices included in the processor-based device 800. As is well known, the processor 802 communicates with these other devices by exchanging address, control, and data information over the system bus 808. For example, the processor 802 can communicate bus transaction requests to a memory controller 810, as an example of a slave device. Although not illustrated in FIG. 8, multiple system buses 808 could be provided, wherein each system bus 808 constitutes a different fabric.

Other master and slave devices can be connected to the system bus 808. As illustrated in FIG. 8, these devices can include a memory system 812 that includes the memory controller 810 and a memory array(s) 814, one or more input devices 816, one or more output devices 818, one or more network interface devices 820, and one or more display controllers 822, as examples. The input device(s) 816 can include any type of input device, including but not limited to input keys, switches, voice processors, etc. The output device(s) 818 can include any type of output device, including, but not limited to, audio, video, other visual indicators, etc. The network interface device(s) 820 can be any device configured to allow exchange of data to and from a network 824. The network 824 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 820 can be configured to support any type of communications protocol desired.

The processor 802 may also be configured to access the display controller(s) 822 over the system bus 808 to control information sent to one or more displays 826. The display controller(s) 822 sends information to the display(s) 826 to be displayed via one or more video processors 828, which process the information to be displayed into a format suitable for the display(s) 826. The display(s) 826 can include any type of display, including but not limited to a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

Implementation examples are described in the following numbered clauses:
1. A processor-based device comprising a workload execution reordering circuit configured to:
   receive a plurality of workloads from a requestor;
   construct a weighted dependency graph based on the plurality of workloads, wherein the weighted dependency graph comprises:
      a plurality of vertices, each corresponding to a workload of the plurality of workloads; and
      one or more directed edges, each connecting two vertices of the plurality of vertices and indicating a dependency between a corresponding two workloads of the plurality of workloads;
   perform a topological sort of the weighted dependency graph; and generate a workload execution order based on the topological sort.
2. The processor-based device of clause 1, wherein the workload execution reordering circuit is further configured to schedule an independent workload among the plurality of workloads to execute during idle time between two dependent workloads among the plurality of workloads, based on the workload execution order.
3. The processor-based device of any one of clauses 1-2, wherein the weighted dependency graph comprises a Directed Acyclic Graph (DAG).
4. The processor-based device of any one of clauses 1-3, wherein the workload execution reordering circuit is configured to perform the topological sort based on Kahn's topological sorting algorithm.
5. The processor-based device of any one of clauses 1-4, wherein:
   a directed edge among the one or more directed edges represents a cross-thread dependency between the corresponding two workloads;
   the workload execution reordering circuit is configured to construct the weighted dependency graph by being configured to associate the directed edge with an edge weight derived from a distance between the two vertices corresponding to the corresponding two workloads; and
   the workload execution reordering circuit is configured to perform the topological sort based on the edge weight.
6. The processor-based device of clause 5, wherein the edge weight is inversely related to the distance between the two vertices corresponding to the two workloads.
7 The processor-based device of any one of clauses 1-6, wherein:
   the workload execution reordering circuit is configured to construct the weighted dependency graph by being further configured to generate, for one or more workloads independent of the cross-thread dependency, a corresponding one or more vertex weights for the one or more vertices corresponding to the one or more workloads; and
   the workload execution reordering circuit is configured to perform the topological sort further based on the one or more vertex weights.
8. The processor-based device of clause 7, wherein each vertex weight of the one or more vertex weights is based on a logical distance from the vertex corresponding to the vertex weight to a vertex corresponding to the workload that caused the cross-thread dependency.
9. The processor-based device of clause 7, wherein the workload execution reordering circuit is configured to perform the topological sort by being further configured to:
   assign a vertex priority to each vertex of the plurality of vertices; and
   process the plurality of vertices in an order indicated by the vertex priority of each vertex.
10. The processor-based device of clause 9, wherein the vertex priority is determined based on an identity of each vertex, a vertex weight of the vertex, and an edge weight of an edge of the vertex.
11. The processor-based device of any one of clauses 1-10, integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.
12. A processor-based device, comprising:
   a means for receiving a plurality of workloads from a requestor;
   a means for constructing a weighted dependency graph based on the plurality of workloads, wherein the weighted dependency graph comprises:
      a plurality of vertices, each corresponding to a workload of the plurality of workloads; and
      one or more directed edges, each connecting two vertices of the plurality of vertices and indicating a dependency between a corresponding two workloads of the plurality of workloads;
   a means for performing a topological sort of the weighted dependency graph; and
   a means for generating a workload execution order based on the topological sort.
13. A method for reordering workloads to improve concurrency across threads, comprising:
   receiving, by a workload execution reordering process executing on a processor-based device, a plurality of workloads from a requestor;
   constructing a weighted dependency graph based on the plurality of workloads, wherein the weighted dependency graph comprises:
      a plurality of vertices, each corresponding to a workload of the plurality of workloads; and
      one or more directed edges, each connecting two vertices of the plurality of vertices and indicating a dependency between a corresponding two workloads of the plurality of workloads;
   performing a topological sort of the weighted dependency graph; and
   generating a workload execution order based on the topological sort.
14. The method of clause 13, further comprising scheduling, by the processor-based device, an independent workload among the plurality of workloads to execute during idle time between two dependent workloads among the plurality of workloads, based on the workload execution order.
15. The method of any one of clauses 13-14, wherein the weighted dependency graph comprises a Directed Acyclic Graph (DAG).
16. The method of any one of clauses 13-15, wherein the topological sort is performed based on Kahn's topological sorting algorithm.
17. The method of any one of clauses 13-16, wherein:
   a directed edge among the one or more directed edges represents a cross-thread dependency between the corresponding two workloads;
   constructing the weighted dependency graph comprises associating the directed edge with an edge weight derived from a distance between the two vertices corresponding to the corresponding two workloads; and
   performing the topological sort based on the edge weight.
18. The method of clause 17, wherein the edge weight is inversely related to the distance between the two vertices corresponding to the two workloads.
19. The method of clause 17, wherein:
   constructing the weighted dependency graph further comprises generating, for one or more workloads independent of the cross-thread dependency, a corresponding one or more vertex weights for the one or more vertices corresponding to the one or more workloads; and
   performing the topological sort further based on the one or more vertex weights.
20. The method of clause 19, wherein each vertex weight of the one or more vertex weights is based on a logical distance from the vertex corresponding to the vertex weight to a vertex corresponding to the workload that caused the cross-thread dependency.
21. The method of clause 19, wherein performing the topological sort further comprises:
   assigning a vertex priority to each vertex of the plurality of vertices; and
   processing the plurality of vertices in an order indicated by the vertex priority of each vertex.
22. The method of clause 21, wherein the vertex priority is determined based on an identity of each vertex, a vertex weight of the vertex, and an edge weight of an edge of the vertex.
23. A non-transitory computer-readable medium having stored thereon computer-executable instructions that, when executed by a processor of a processor-based device, cause the processor to:
   receive a plurality of workloads from a requestor;
   construct a weighted dependency graph based on the plurality of workloads, wherein the weighted dependency graph comprises:
      a plurality of vertices, each corresponding to a workload of the plurality of workloads; and
      one or more directed edges, each connecting two vertices of the plurality of vertices and indicating a dependency between a corresponding two workloads of the plurality of workloads;
   perform a topological sort of the weighted dependency graph; and
   generate a workload execution order based on the topological sort.

What is claimed is:

1. A processor-based device comprising a workload execution reordering circuit configured to:
receive a plurality of workloads from a requestor;
construct a weighted dependency graph based on the plurality of workloads, wherein the weighted dependency graph comprises:
a plurality of vertices, each corresponding to a workload of the plurality of workloads; and
one or more directed edges, each connecting two vertices of the plurality of vertices and indicating a dependency between a corresponding two workloads of the plurality of workloads;
perform a topological sort of the weighted dependency graph; and
generate a workload execution order based on the topological sort.

2. The processor-based device of claim 1, wherein the workload execution reordering circuit is further configured to schedule an independent workload among the plurality of workloads to execute during idle time between two dependent workloads among the plurality of workloads, based on the workload execution order.

3. The processor-based device of claim 1, wherein the weighted dependency graph comprises a Directed Acyclic Graph (DAG).

4. The processor-based device of claim 1, wherein the workload execution reordering circuit is configured to perform the topological sort based on Kahn's topological sorting algorithm.

5. The processor-based device of claim 1, wherein:
a directed edge among the one or more directed edges represents a cross-thread dependency between the corresponding two workloads;
the workload execution reordering circuit is configured to construct the weighted dependency graph by being configured to associate the directed edge with an edge weight derived from a distance between the two vertices corresponding to the corresponding two workloads; and
the workload execution reordering circuit is configured to perform the topological sort based on the edge weight.

6. The processor-based device of claim 5, wherein the edge weight is inversely related to the distance between the two vertices corresponding to the two workloads.

7. The processor-based device of claim 5, wherein:
the workload execution reordering circuit is configured to construct the weighted dependency graph by being further configured to generate, for one or more workloads independent of the cross-thread dependency, a corresponding one or more vertex weights for the one or more vertices corresponding to the one or more workloads; and
the workload execution reordering circuit is configured to perform the topological sort further based on the one or more vertex weights.

8. The processor-based device of claim 7, wherein each vertex weight of the one or more vertex weights is based on a logical distance from the vertex corresponding to the vertex weight to a vertex corresponding to the workload that caused the cross-thread dependency.

9. The processor-based device of claim 7, wherein the workload execution reordering circuit is configured to perform the topological sort by being further configured to:
assign a vertex priority to each vertex of the plurality of vertices; and
process the plurality of vertices in an order indicated by the vertex priority of each vertex.

10. The processor-based device of claim 9, wherein the vertex priority is determined based on an identity of each vertex, a vertex weight of the vertex, and an edge weight of an edge of the vertex.

11. The processor-based device of claim 1, integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multi copter.

12. A processor-based device, comprising:
a means for receiving a plurality of workloads from a requestor;
a means for constructing a weighted dependency graph based on the plurality of workloads, wherein the weighted dependency graph comprises:
a plurality of vertices, each corresponding to a workload of the plurality of workloads; and
one or more directed edges, each connecting two vertices of the plurality of vertices and indicating a dependency between a corresponding two workloads of the plurality of workloads;
a means for performing a topological sort of the weighted dependency graph; and
a means for generating a workload execution order based on the topological sort.

13. A method for reordering workloads to improve concurrency across threads, comprising:
receiving, by a workload execution reordering process executing on a processor-based device, a plurality of workloads from a requestor;
constructing a weighted dependency graph based on the plurality of workloads, wherein the weighted dependency graph comprises:
a plurality of vertices, each corresponding to a workload of the plurality of workloads; and
one or more directed edges, each connecting two vertices of the plurality of vertices and indicating a dependency between a corresponding two workloads of the plurality of workloads;
performing a topological sort of the weighted dependency graph; and
generating a workload execution order based on the topological sort.

14. The method of claim 13, further comprising scheduling, by the processor-based device, an independent workload among the plurality of workloads to execute during idle time between two dependent workloads among the plurality of workloads, based on the workload execution order.

15. The method of claim 13, wherein the weighted dependency graph comprises a Directed Acyclic Graph (DAG).

16. The method of claim 13, wherein the topological sort is performed based on Kahn's topological sorting algorithm.

17. The method of claim 13, wherein:
a directed edge among the one or more directed edges represents a cross-thread dependency between the corresponding two workloads;
constructing the weighted dependency graph comprises associating the directed edge with an edge weight derived from a distance between the two vertices corresponding to the corresponding two workloads; and
performing the topological sort based on the edge weight.

18. The method of claim 17, wherein the edge weight is inversely related to the distance between the two vertices corresponding to the two workloads.

19. The method of claim 17, wherein:
constructing the weighted dependency graph further comprises generating, for one or more workloads independent of the cross-thread dependency, a corresponding one or more vertex weights for the one or more vertices corresponding to the one or more workloads; and
performing the topological sort further based on the one or more vertex weights.

20. The method of claim 19, wherein each vertex weight of the one or more vertex weights is based on a logical distance from the vertex corresponding to the vertex weight to a vertex corresponding to the workload that caused the cross-thread dependency.

21. The method of claim 19, wherein performing the topological sort further comprises:
assigning a vertex priority to each vertex of the plurality of vertices; and
processing the plurality of vertices in an order indicated by the vertex priority of each vertex.

22. The method of claim 21, wherein the vertex priority is determined based on an identity of each vertex, a vertex weight of the vertex, and an edge weight of an edge of the vertex.

23. A non-transitory computer-readable medium having stored thereon computer-executable instructions that, when executed by a processor of a processor-based device, cause the processor to:
receive a plurality of workloads from a requestor;
construct a weighted dependency graph based on the plurality of workloads, wherein the weighted dependency graph comprises:
a plurality of vertices, each corresponding to a workload of the plurality of workloads; and
one or more directed edges, each connecting two vertices of the plurality of vertices and indicating a dependency between a corresponding two workloads of the plurality of workloads;
perform a topological sort of the weighted dependency graph; and
generate a workload execution order based on the topological sort.
